(19) United States
(12) Patent Application Publication
(10) Pub. No.: US 2024/0032635 A1
(43) Pub. Date: Feb. 1, 2024

(54) FACE MASK HOLDER

(71) Applicant: NIKE Inc., Beaverton, OR (US)

(72) Inventors: George S. Kim, Wilsonville, OR (US); Austin J. Orand, Portland, OR (US)

(21) Appl. No.: 18/227,101

(22) Filed: Jul. 27, 2023

Related U.S. Application Data
(60) Provisional application No. 63/393,608, filed on Jul. 29, 2022.

(51) Int. Cl. A42B 1/24; A62B 25/00

(52) U.S. Cl. CPC A42B 1/24; A62B 25/00

(57) ABSTRACT

Aspects herein relate to articles of apparel having anchoring devices that engage face masks in a convenient and accessible way. For example, the anchoring devices in accordance with aspects herein can be concealed in a hidden state when not in use, and can be in an anchoring state when in use.

### CROSS-REFERENCE TO RELATED APPLICATIONS

This application having Attorney Docket No. 405367/220026US02, and entitled “Face Mask Holder” claims the benefit of priority to U.S. Prov. App. No. 63/393,608, filed on Jul. 29, 2022, and entitled “Face Mask Holder.” The entirety of the aforementioned application is incorporated by reference herein.

### TECHNICAL FIELD

Aspects herein relate to articles of apparel having structures that engage face masks in a convenient and accessible way, and methods for their use. For example, aspects herein disclose headwear having anchoring elements.

### BACKGROUND

Traditionally, face mask are provided with a pair of elastic ear loops configured to be hooked behind each ear of a wearer. Other face masks are provided with ties or elastic bands that go over a wearer's head over the wearer's crown and nape. However, these face masks are not comfortable to wear over extended periods of time. Particularly, the elastic ear loops tend to cause ear pain and irritation to the wearer's ears when the face mask is worn for an extended period of time as the ear loops tend to pull on the wearer's ears. Additionally, since face masks tend to be provided in standard sizes, a fit of a face mask may not be optimal for all wearers.

### BRIEF DESCRIPTION OF THE DRAWINGS

Examples of aspects herein are described in detail below with reference to the attached drawing figures, wherein:

FIG. 1A illustrates a wearer wearing an embodiment of an article integrating an anchoring device, in accordance with aspects herein;

FIG. 1B illustrates the wearer in FIG. 1A having a face mask held in place by the anchoring device, in accordance with aspects herein;

FIG. 1C illustrates the wearer in FIGS. 1A-1B wearing a face mask held in place by the anchoring device, in accordance with aspects herein

FIG. 2A illustrates a top-down perspective view of the article shown in FIGS. 1A-1C with the anchoring device being in an anchoring state;

FIG. 2B illustrates a top-down perspective view of the article shown in FIGS. 1A-1C with the anchoring device having one anchor in an anchoring state and another anchor in a hidden state;

FIGS. 3A-3C illustrate a side perspective view of the article shown in FIGS. 1A-1C in different states, in accordance with aspects herein.

FIG. 4A depicts a cross-sectional view of a cross-section taken at line 4A-4A in FIG. 3A, in accordance with aspects herein;

FIG. 4B depicts a cross-sectional view of a cross-section taken at line 4B-4B in FIG. 3B, in accordance with aspects herein;

FIG. 4C depicts a cross-sectional view of a cross-section taken at line 4C-4C in FIG. 3C, in accordance with aspects herein;

FIG. 5 illustrates a bottom-up perspective view of the article shown in FIGS. 1A-1C;

FIG. 6A illustrates another embodiment of an article integrating an anchoring device, in accordance with aspects herein;

FIG. 6B depicts a cross-sectional view of a cross-section taken at line 6B-6B in FIG. 6A, in accordance with aspects herein;

FIGS. 6C-6D illustrate different configurations for the slit(s), in accordance with aspects herein;

FIG. 7A illustrates a different embodiment of an article integrating an anchoring device, in accordance with aspects herein;

FIG. 7B depicts a cross-sectional view of a cross-section when the anchoring device is in a non-anchoring state, in accordance with aspects herein;

FIG. 7C depicts a cross-sectional view of the cross-section taken at line 7C-7C in FIG. 7A when the anchoring device is in an anchoring state, in accordance with aspects herein;

FIG. 8A illustrates an additional embodiment of an article integrating an anchoring device, in accordance with aspects herein;

FIG. 8B depicts a cross-sectional view of a cross-section taken at line 8B-8B in FIG. 8A, in accordance with aspects herein;

FIG. 9A illustrates an additional embodiment of an article integrating an anchoring device, in accordance with aspects herein;

FIG. 9B depicts a cross-sectional view of a cross-section taken at line 9B-9B in FIG. 9B, in accordance with aspects herein;

FIG. 10A-10C depict perspective views of an adjustable anchoring device integrated in the article shown in FIG. 10A, in accordance with aspects herein;

FIG. 11 illustrates an additional embodiment of an article integrating an anchoring device, in accordance with aspects herein;

FIG. 12 illustrates an additional embodiment of an article integrating an anchoring device, in accordance with aspects herein; and

FIG. 13 illustrates an additional embodiment of an article integrating an anchoring device, in accordance with aspects herein.

### DETAILED DESCRIPTION

The subject matter of the present invention is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” and/or “block” might be used herein to connote different elements of methods employed, the terms should not be interpreted as implying any particular order among or between various steps herein disclosed unless and except when the order of individual steps is explicitly stated.

Traditionally, face masks are provided with straps, loops, or bands to be worn over a wearer's head or to be anchored on a wearer's ears. However, when the face masks need to be worn for extended periods of time, they can become less secure and/or uncomfortable causing pain to the wearer, particularly when anchored on the wearer's ears.

Articles having anchoring devices are provided herein. The articles in accordance with aspects herein can be worn over a wearer's head. The anchoring devices provided in accordance with aspects herein can be hidden from view and thus discrete when not in use. In other words, the articles provided in accordance with aspects herein, in addition to providing their conventional function, advantageously offer the additional function of providing an anchoring device for a face mask of a user so that instead of a tensioning force of the face mask's straps, loops, or bands, being directly imposed on the wearer's head or ears, the tensioning force is transferred to the anchoring device of the articles provided in accordance with aspects herein.

At a high level, aspects herein are directed to a headwear article such as a cap (commonly known as baseball cap), hat, or head band. Conventionally, the headwear article provides shade to a wearer's head and particularly to a wearer's face in the case of hats or caps, in the case of a headband, the headband is typically configured to hold the wearer's hair away from the wearer's face and/or provide a sweat barrier so that sweat is prevented from falling into the wearer's eyes. In accordance with aspects herein, the headwear articles, in addition to performing their conventional functions, further provide an anchoring device for a face mask when needed.

The anchoring device in accordance with aspects herein is configured to be hidden from view when not in use, thereby not affecting the aesthetic appeal of the headwear article. When in use, the anchoring device can be moved from a hidden state to an anchoring state with minimal effort from the wearer, as will become more apparent with respect to the figures.

Positional terms as used herein to describe a headwear article are with respect to the headwear article being worn as intended by a wearer standing upright. The term “inner-facing surface” means the surface of the headwear article that is configured to face toward a skin surface of a wearer. In example aspects, the inner-facing surface may be the innermost-facing surface of the headwear article. The term “outer-facing surface” means the surface of the headwear article that faces away from the inner-facing surface and toward an external environment. In example aspects, the outer-facing surface may be the outermost-facing surface of the headwear article. In accordance with aspects herein, the inner-facing surface may comprise the technical front of a textile and the outer-facing surface may comprise the technical back of the textile.

When the headwear article is in an as-worn configuration, the term “front” means that portion of the headwear article is aligned with a wearer's face, and the term “back” means that portion of the headwear article is aligned with a wearer's back. The term “side” means that portion of the headwear article is aligned with the wearer's ears.

The anchoring devices in accordance with aspects herein may be in the form of buttons, hooks, and the like, that are structurally suitable to function in accordance with aspects herein. The anchoring devices may be made of recyclable plastics, or other polymer materials, or metals and metal alloys that are suitable in accordance with aspects herein.

The term “hidden state” as used herein broadly means that the anchoring device is hidden from direct view. In other words, when in the “hidden state,” the anchoring device is covered from view by, for example, a layer of the headwear article. The term “anchoring state” as used herein broadly means that the anchoring device is exposed and ready to perform its anchoring function. In other words, in the “anchoring state,” the anchoring device is uncovered and fully visible and exposed.

In accordance with aspects herein, the anchoring device may be chosen to blend in when in its anchoring state, for example, by being the same color as the headwear device. In accordance with other aspects herein, the anchoring device may be chosen to stand out in its anchoring state, for example, by being a different color from the headwear article, by having visual markings or indicia thereon, or by being provided with, for example, jewels, rhinestones, glitter, and the like. In these aspects, a color may comprise a numerical color value, which may be determined by using instruments that objectively measure and/or calculate color values of a color of an object by standardizing and/or quantifying factors that may affect a perception of a color. Such instruments include, but are not limited to spectroradiometers, spectrophotometers, and the like. Thus, aspects herein contemplate that a “color” may comprise a numerical color value that is measured and/or calculated using spectroradiometers and/or spectrophotometers. Moreover, numerical color values may be associated with a color space or color model, which is a specific organization of colors that provides color representations for numerical color values, and thus, each numerical color value corresponds to a singular color represented in the color space or color model. In these aspects, a color may be determined to be different from another color if a numerical color value of each color differs. If the numerical color values are not equal, then the first color is different than the second color, and vice versa.

Further, although the figures depict the anchor devices having certain shapes, for example, circular, it is contemplated that the anchoring devices in accordance with aspects herein may have other shapes that are suitable such as organic shapes, geometric shapes, character shapes, and the like. For example, stars, hearts, animals, ellipse, and the like, without departing from aspects disclosed herein.

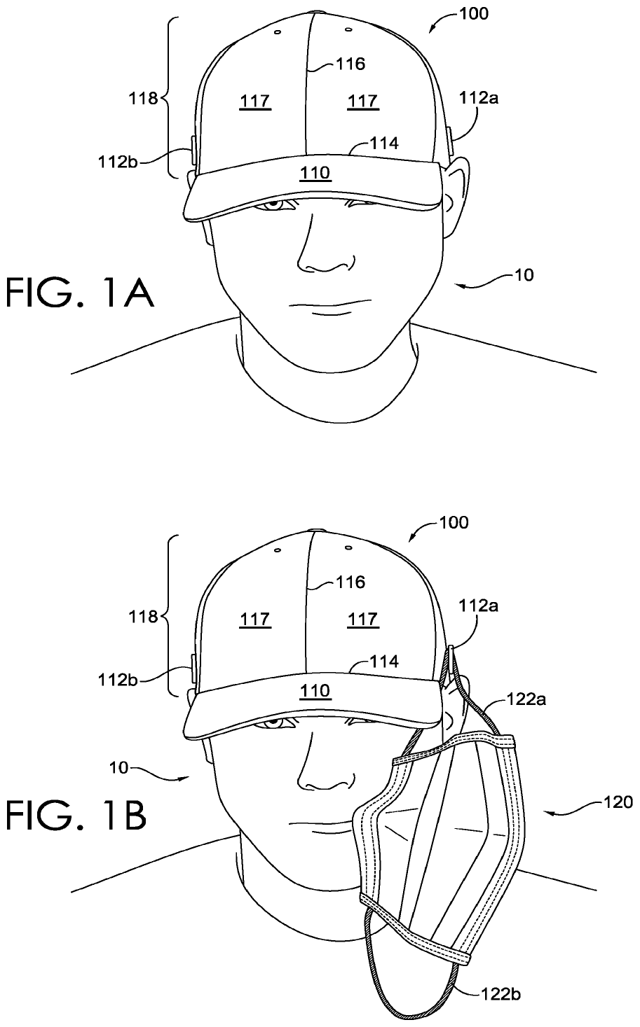

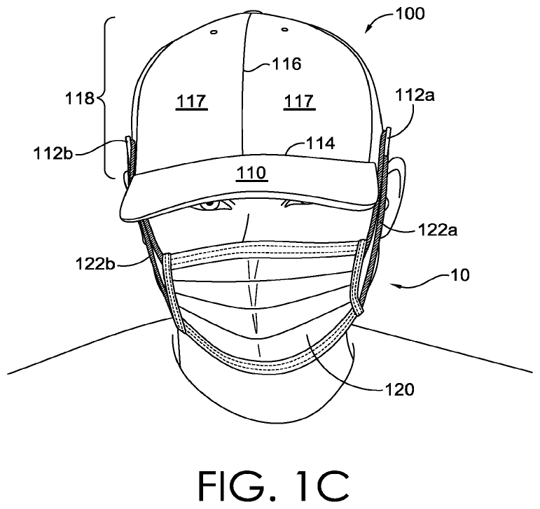

FIG. 1A illustrates a wearer 10 wearing an embodiment of an article integrating an anchoring device, in accordance with aspects herein. As shown, the article can be a headwear article configured to be worn on a wearer's head. For example, the article can be a hat, a headband, or a cap 100 (e.g., baseball type cap) as shown. As shown, the cap 100 can be configured to perform its conventional function to provide shading to the face of the wearer 10 via the visor 110. In accordance with aspects herein, the cap 100 may comprise a pair of anchoring devices 112a and 112b configured to align with left and right temporal bones of the wearer 10, respectively. As shown, the head covering portion 118 of the cap 100 may be formed by stitching a plurality of panels forming seams 116, the plurality of panels 117, once stitched together collectively form a perimeter edge 114 extending along a circumference of the head covering portion 118, to which the visor 110 is attached. The seams 116 extend perpendicular to the perimeter edge 114. FIG. 1B illustrates the wearer 10 in FIG. 1A having a face mask 120 held in place or hanging from the anchoring device 112a, in accordance with aspects herein. As shown, the face mask 120 can hang from or be held in place by a respective ear loop 122a or 122b, respectively. FIG. 1C illustrates the wearer in FIGS. 1A and 1B fully wearing the face mask 120, which is held in place on the face of the wearer 10 via anchoring devices 112a and 112b, which are configured to interact with ear loops 122a and 122b respectively.

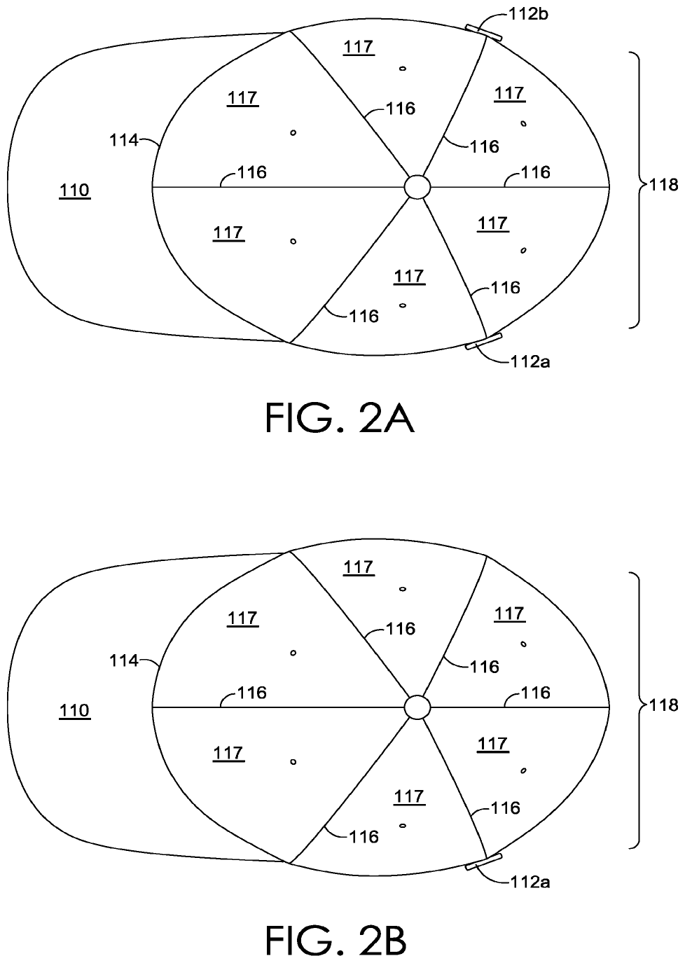

FIG. 2A illustrates a top-down perspective view of the cap 100 shown in FIGS. 1A-1C with the anchoring devices 112a and 112b being in an anchoring state, and FIG. 2B illustrates a top-down perspective view of the cap 100 shown in FIGS. 1A-1C with the anchoring devices 112a and 112b having one anchoring device 112a in an anchoring state and the anchoring device 112b in a hidden state.

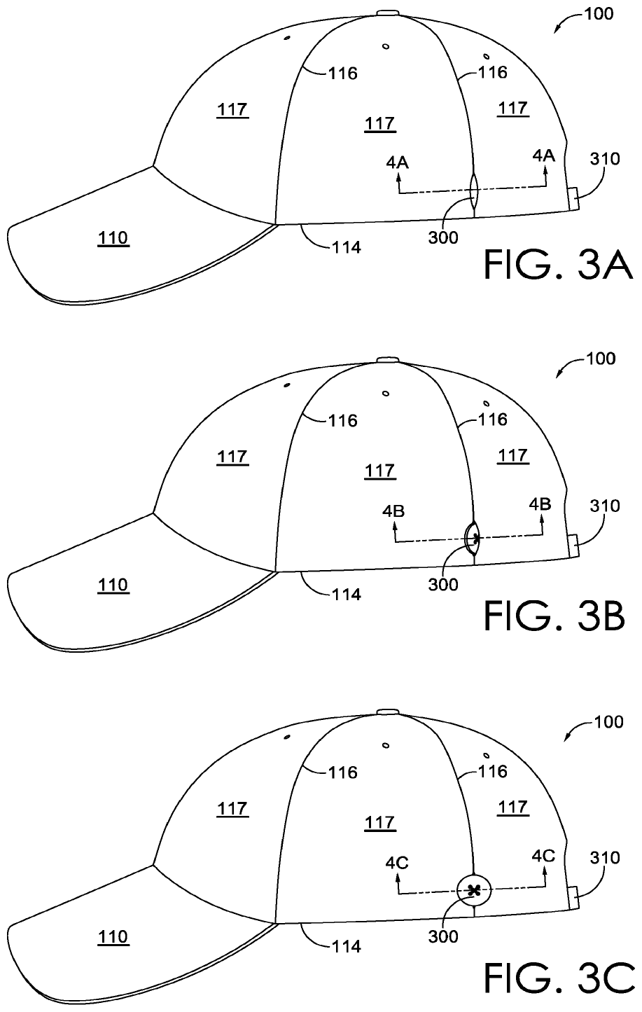

FIGS. 3A-3C illustrate a side perspective view of the cap 100 shown in FIGS. 1A-1C in different states, in accordance with aspects herein. Specifically FIG. 3A shows the cap 100 having the anchoring device 112a as being in a hidden state. As shown, cap 100 comprises a slit 300, which provides a passageway for the anchoring device 112a, for example, to pass through, as is shown in FIG. 3B, where the anchoring device 112a is shown in transition from the hidden state to the anchoring state, which is shown in FIG. 3C. As shown in FIG. 3C, the anchoring device 112a is fully exposed and ready to function as an anchoring point for securing a face mask, as is shown in FIG. 1C. Further, as shown in FIGS. 3A-3C, the cap 100 may comprise an adjustable mechanism 310 that helps adjust a fitting of the cap 100 to the wearer's preferences.

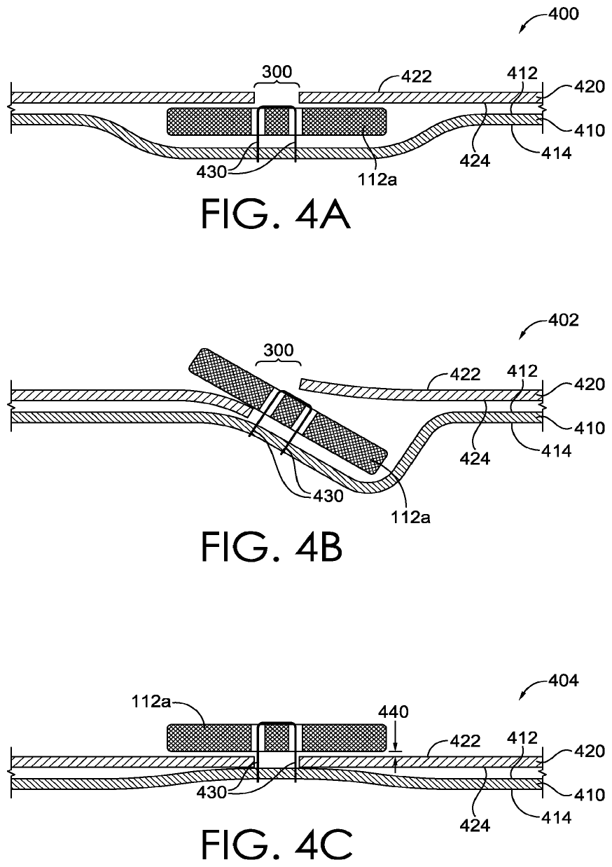

FIG. 4A depicts a cross-sectional view 400 of a cross-section taken at line 4A-4A in FIG. 3A, in accordance with aspects herein. As shown, the anchoring device 112a is secured to a first layer 410 of the cap 100 shown in FIG. 3A. The anchoring device 112a may be secured through securing element 430 (e.g., threading), as shown, or alternatively, may be bonded to the surface 412 of the first layer 410, that faces away from the wearer, while the surface 414 that faces the wearer is configured to maintain its relatively flat profile, so as to provide comfort to the wearer when the cap 100 is worn by the wearer. The securing element 430 in accordance with some aspects may have some elasticity, which would help in the manipulation of the anchoring device 112a when transitioning from the hidden state to the anchoring state, and vice versa. In other words, the securing element 430 may have a modulus of elasticity that is less than or equal to a modulus of elasticity of the first layer 410. The anchoring device 112a can be, configured, for example, as a button, as shown. The anchoring device 112a may have a round profile, as shown, or as described above, may have any shape suitable such as an organic shape, a geometric shape, an animal shape, etc., that would be suitable. The anchoring device 112a, when in the hidden state, as shown, resides between the surface 412 of the first layer 410, and the surface 424 of the second layer 420, that faces the wearer. The second layer 420 is comprised of one panel 117, where the surface 422 is configured to be exposed to the external environment. As can be further observed, the slit 300 is in general alignment with the anchoring device 112a. As shown in FIGS. 4A-4C, the surface 424 of the second layer 420 and the surface 412 of the first layer 410 are in a face-sharing relationship when the cap 100 is in a configuration that is ready to function as intended when the cap 100 is worn by the wearer.

FIG. 4B depicts a cross-sectional view 402 of a cross-section taken at line 4B-4B in FIG. 3B, which illustrates a transitional state between the hidden state shown in FIG. 4A to the anchoring state shown in FIG. 4C. As shown, because the first layer 410 and the second layer 420 are comprised of pliable materials such as, for example, woven or knit textiles, mesh materials, and the like, the first layer 410 and the second layer 420 can be manipulated to extend the anchoring device 112a through the slit 300.

FIG. 4C depicts a cross-sectional view 404 of a cross-section taken at line 4C-4C in FIG. 3C, which illustrates the anchoring device 112a in the anchoring state, as it is fully exposed and sits on top of surface 422 of the second layer 420. The ear loops of the face mask, in the anchoring state of the anchoring device 112a, are configured to be inserted through the gap 440 formed between the anchoring device 112a and the surface 422 of the second layer 420, and may engage with the securing element 430. Because of the tension created between the anchoring device 112a and the surface 422 of the second layer 420 by the securing element 430, there may be a gripping effect for the ear loop of the face mask, which ensures that the face mask is effectively secured to the anchoring device 112a. Although, the description in FIGS. 3A-4C has been provided with respect to only anchoring device 112a, in accordance with aspects herein, the same features and configurations are contemplated to be true for other anchoring devices that may be present (e.g., anchoring device 112b).

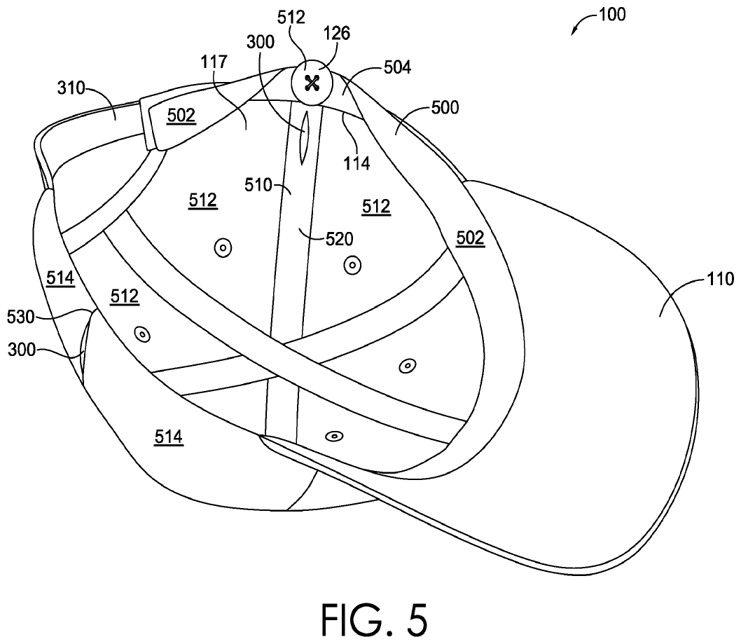

FIG. 5 illustrates a bottom-up perspective view of the cap 100 shown in FIGS. 1A-1C. As shown, the cap 100 comprises a first layer 500 such as, for example, a sweat band, that comprises a first surface 502 and a second surface 504. The plurality of panels 117 collectively forming the body of the cap 100, collectively have an interior surface 512 configured to be in contact with a wearer's head when the cap 100 is worn, and an opposite exterior surface 514 exposed to an external environment. As shown, the first surface of the first layer 500 is affixed to the perimeter edge 114 of the body of the cap 100 such that the first surface 502 is configured to be in contact with the wearer's head when the cap 100 is worn and the second surface 504 is generally configured to be in a face sharing relationship with the interior surface 512 of the body of the cap 100 in the fully constructed cap 100. As shown in FIG. 5 the anchoring device 112b (112a not shown) is affixed to the second surface 504 so that the anchoring devices 112a and 112b are hidden, or stowed away behind the first layer 100 in between the second surface 504 of the first layer 500 and the interior surface 512 of the body of the cap 100 when the anchoring devices 112a and 112b are not in use. As also shown in FIG. 5, the positioning of the anchoring device 112b (and 112a) is generally aligned with the slit 300 for ready access to the anchoring device 112b (112a) when the anchoring device 112b (112a) is transitioned from the hidden state to the anchoring state.

Further, for further discreteness, the slit 300 may generally be aligned with a seam 530 joining the plurality of panels 117 to one another to form the body of the cap 100. In other words, the slit 300 may extend orthogonal to the perimeter edge 114 of the body of the cap 100 along a seam 530, resulting in the aesthetics of the exterior surface 514 of the body of the cap 100 not being substantially changed when the anchoring device 112b (112a) is in the hidden state. In other words, the exterior surface 514 of the body of the cap 100 will generally look and function as a cap not having the anchoring device. As further shown, the seams 530 can be reinforced by a tape or layer 510 on the interior surface 512 of the body of the cap 100.

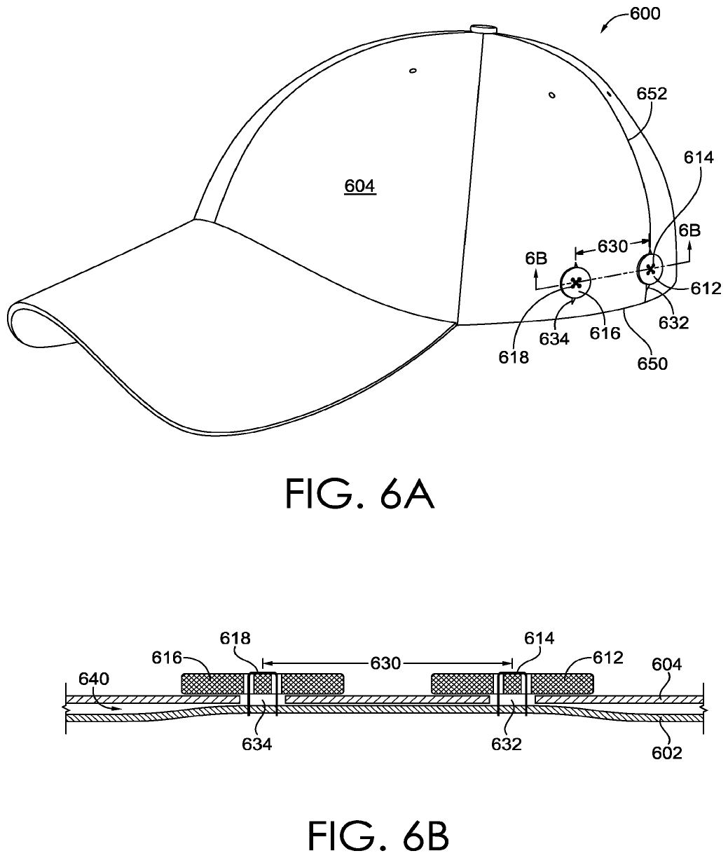

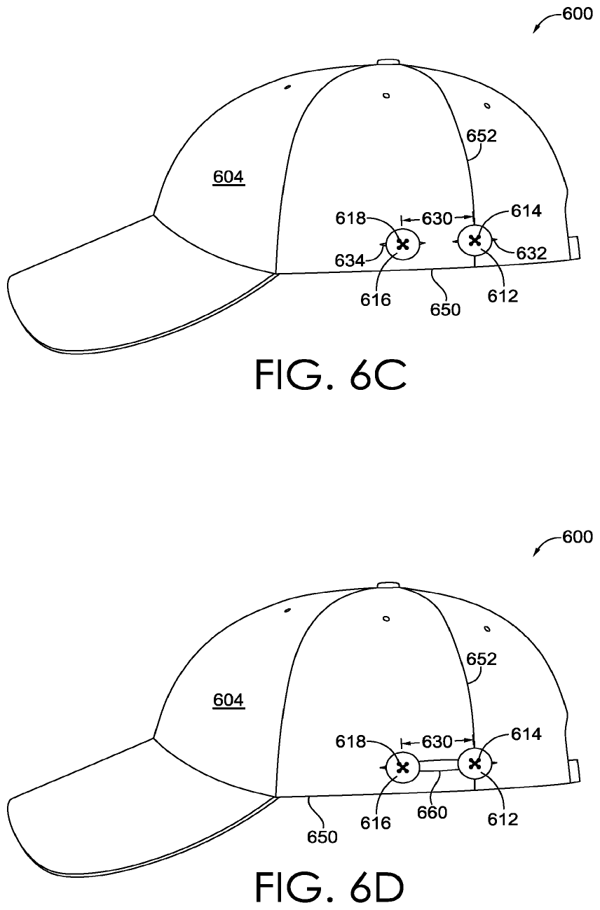

FIG. 6A illustrates an additional embodiment of an article 600 integrating an anchoring device, in accordance with aspects herein. As shown, the article 600 can be equipped with multiple anchoring devices on each respective side (right side/left side) of the article 600. For example, the article 600 can provide two or more anchoring positions on each respective side for providing improved adjustability of a face mask when the face mask is anchored to the article 600. This can be done by providing a first anchoring device 612 and a second anchoring device 616, where the position of the first anchoring device 612 is offset from a position of the second anchoring device 616 by a distance 630, measured from a first slit 632 aligning with anchoring device 612 to a slit 634 aligning with the anchoring device 616, as is more apparent from the cross-sectional view provided at FIG. 6B taken at line 6B-6B in FIG. 6A. Similar to cap 100, the anchoring devices 612 and 616 are affixed through securing elements 614 and 618, respectively, to the layer 602 (forming, for example, a sweatband of the article 600) so that in the hidden state (not shown), the anchoring devices 612 and 616 are stowed or hidden in the space 640 formed between the layer 602 and the external layer 604 of the article 600, and in the anchoring state (as shown in FIGS. 6A and 6B), the anchoring devices 612 and 616 can be individually manipulated as needed to extend through a respective slit 632 or 634 of the external layer 604.

As shown in FIG. 6A, the first slit 632 and the second slit 634 are in a general orthogonal alignment with the edge 650 of the article 600, which may conceal at least one of the slits along a body seam 652. However, as shown in FIG. 6C, it is also contemplated that the slit 632 and the slit 634 may be in parallel alignment with the edge 650 of the article 600. In further aspects, as further illustrated in FIG. 6D, it is also contemplated that a single slit 660 may be provided to functionally operate with both the first anchoring device 612 and the second anchoring device 616. The slit 660 being in a general parallel alignment with the edge 650 of the article 600.

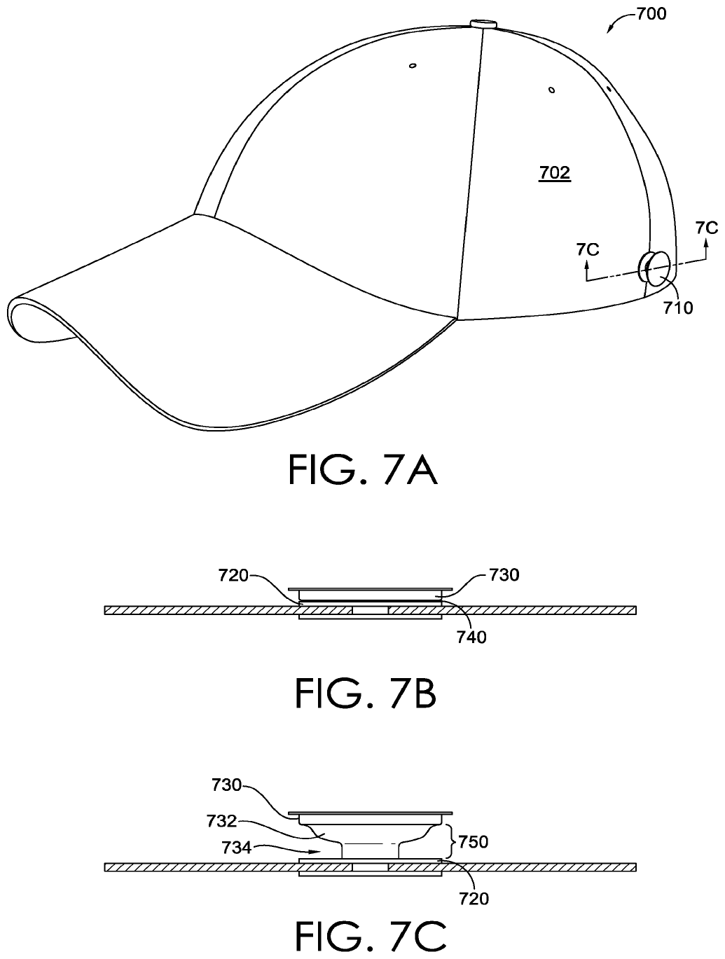

FIGS. 7A-7C illustrate an additional embodiment of an article 700 integrating an anchoring device 710, in accordance with aspects herein. As shown more clearly in FIGS. 7B and 7C, the anchoring device 710 may comprise a base portion 720 and an anchoring portion 730. The anchoring portion 730 may be configured to expand and contract such that in a hidden state (as shown in the cross-sectional view provided in FIG. 7B), the base portion and the anchoring portion 730 are minimally separated or in contact with each other by a first distance 740. In the anchoring state (as shown in the cross-sectional view provided in FIG. 7C), the base portion 720 and the anchoring portion 730 may be separated by a second distance 750, where the second distance 750 is greater than the first distance 740. To facilitate the expansion and contraction of the anchoring device 750 such that the base portion a, and in an anchoring state, the base portion 720 and the anchoring portion 730 may be joined to each other by a body portion 732 that may be elastic and shaped to create a groove 734 in the anchoring state to accommodate at least one ear loop of a face mask. Although shown as the anchoring device 710 being affixed to and extending from the exterior surface 702 of the article 700, it is contemplated that like the cap 100 shown in FIGS. 3A-4C, the anchoring device 710 may be affixed to an interior layer of the article 710 so that it can be concealed by the exterior surface 702 of the article 700 in a hidden state, and extend through a discrete slit when in an anchoring state.

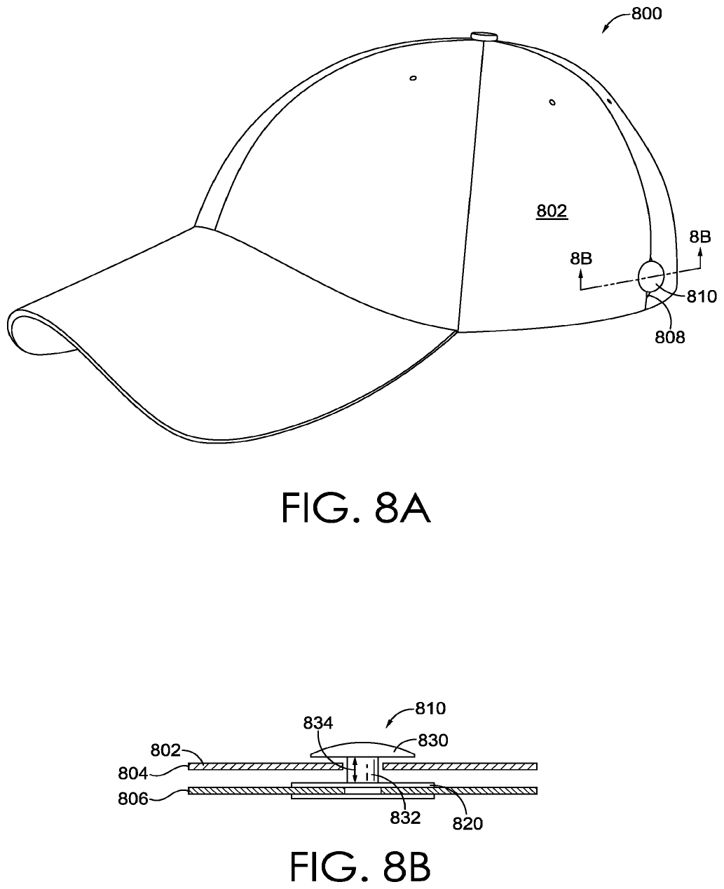

FIGS. 8A and 8B illustrate an embodiment of an anchoring device 810 affixed to an article 800, where the anchoring device 810, where contrary to the embodiment shown in FIGS. 7A-7C, comprises a rigid body portion 832 between the base portion 820 and the anchoring portion 830. As shown in FIGS. 8A and 8B, the base portion 820 of the anchoring device 810 is secured to an interior layer 806 of the article 800 so that in a hidden state, the anchoring portion 830 is hidden behind a body layer 804 of the article 800. In the anchoring state, as shown, the anchoring device 810 may extend through a slit 808 formed on the body layer 804 of article 800 such that the anchoring portion 830 extends over the surface 802 of the body layer 804. The length 834 of the rigid body portion 832 may be long enough to provide the desired functionality, but short enough to provide discreteness when the anchoring device 810 is in the hidden state for example, the length may be from 0.3 cm to 1 cm.

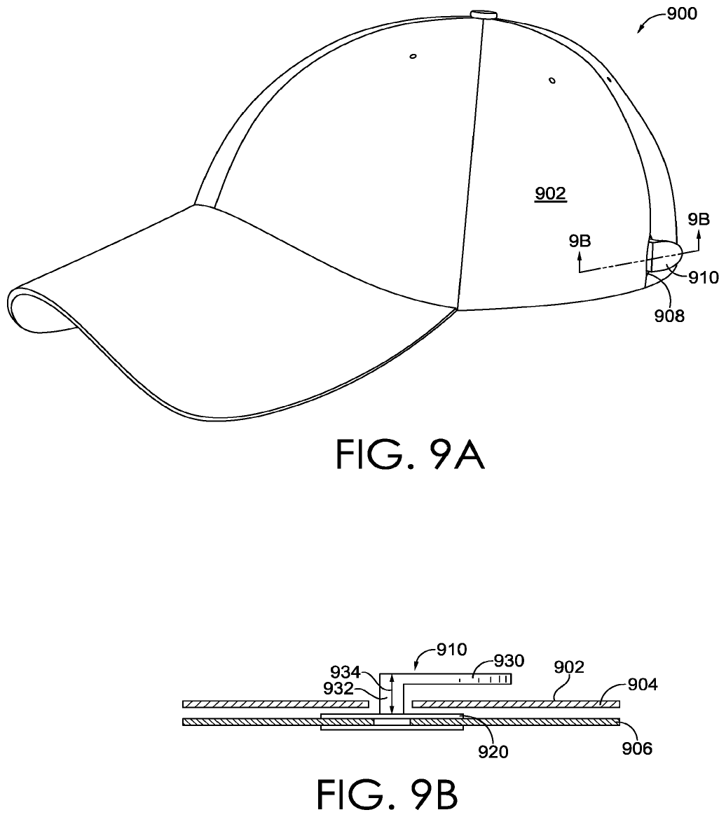

FIGS. 9A and 9B illustrate an embodiment of an anchoring device 910, where the anchoring device 910 is shaped like a hook affixed to an article 900, where the anchoring device 910 comprising a rigid body portion 932 between the base portion 920 and the anchoring portion 930. As clearly seen, the anchoring portion 930 is positioned to extend pointing toward the back of article 900 to provide an anchoring point using the body portion 932 located between the anchoring portion 930 and the base portion 920. As shown in FIGS. 9A and 9B, the base portion 920 of the anchoring device 910 is secured to an interior layer 906 of the article 900 so that in a hidden state, the anchoring portion 930 is hidden behind a body layer 904 of the article 900. In the anchoring state, as shown, the anchoring device 910 may extend through a slit 908 formed on the body layer 904 of article 900 such that the anchoring portion 930 extends over the surface 902 of the body layer 904. The length 934 of the body portion 932 may be long enough to provide the desired functionality, but short enough to provide discreteness when the anchoring device 910 is in the hidden state for example, the length may be from 0.3 cm to 1 cm.

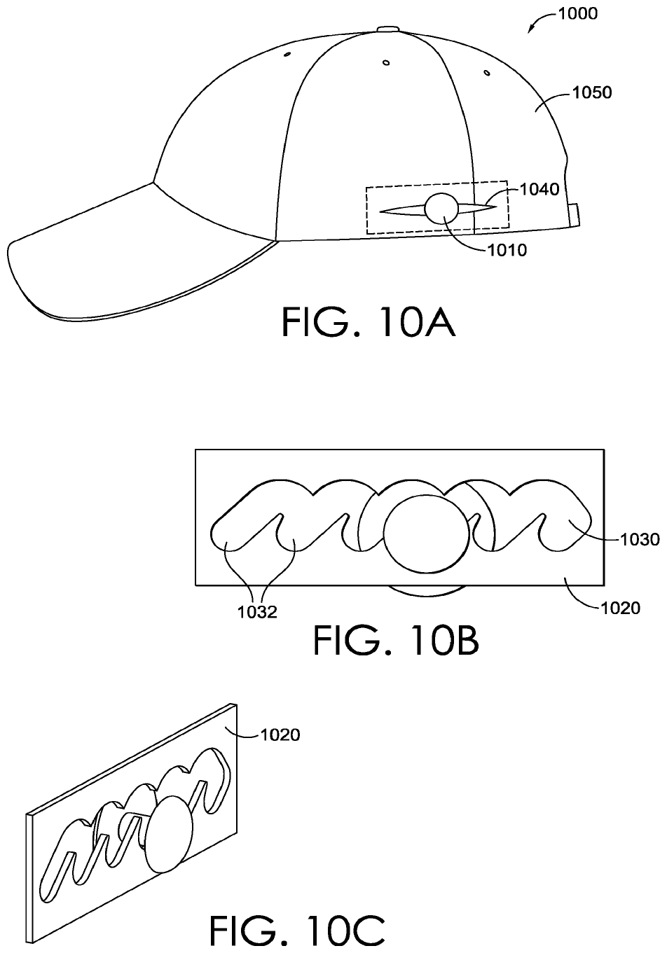

In accordance with further aspects, adjustability may be desirable. Thus, as shown in FIG. 10A, an additional embodiment of an article 1000 integrating an adjustable anchoring device 1010, is provided. As shown in FIGS. 10B and 10C. The anchoring device 1010 may be similar to the anchoring device shown in FIGS. 8A-8B. However, rather than being affixed to an interior layer of the article 1000, the anchoring device 1010 may be provided with a track 1020 providing a path 1030 having a plurality of anchoring positions 1032 along the path 1030. The track 1020 may be affixed to an inner layer of the article 1000, as previously described with respect to cap 100. Further, the track 1020 may be aligned with slit 1040 provided on the body layer 1050 of the article 1000 so that in an anchoring state, as shown in FIG. 10A, the anchoring device 1010 can be brought out exterior to the body layer 1050. Depending on a desired fit, a user may move the anchoring device 1010 along the track 1020 to the different anchoring points 1032 until a desired fit is achieved for an anchored face mask.

Although not specifically shown, it is also contemplated that the articles in accordance with aspects herein may comprises a combination of different types of anchoring devices. For example, rather than having the same type of anchoring device on both sides of the article, the article may be equipped with one type of anchoring device on one side (e.g., a button as shown in FIG. 3A), and another type of anchoring device on the other side (e.g., a hook as shown in FIG. 9A). This would provide further versatility in some aspects.

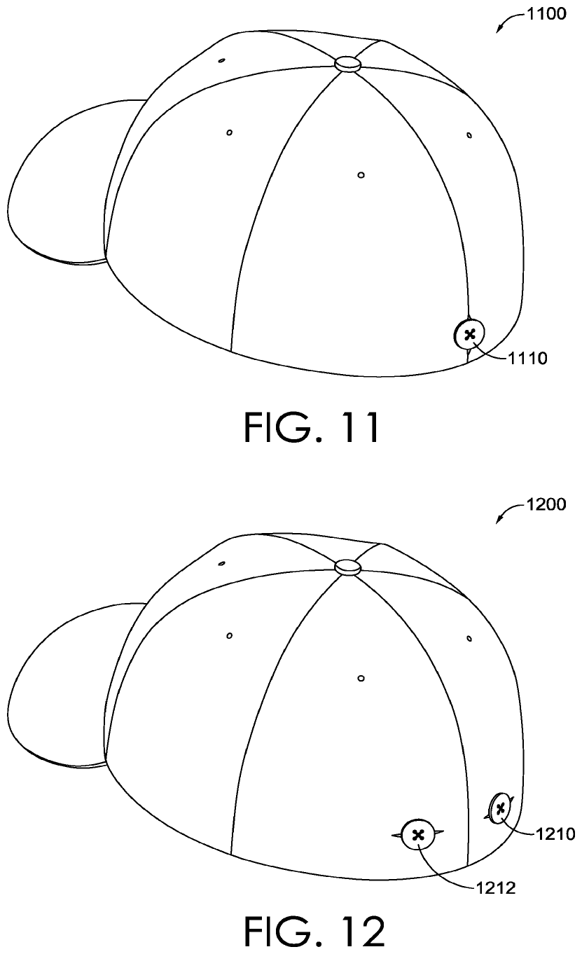

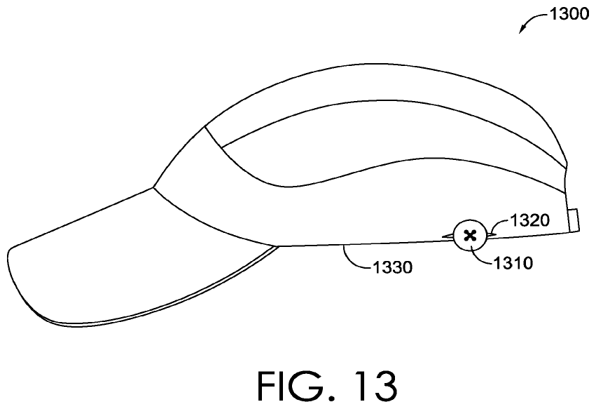

Furthermore, although the anchoring devices in accordance to aspects herein are shown as generally aligning with right and left temporal bones of a wearer when the articles are worn, it is also contemplated that, as shown in FIG. 11 and FIG. 12, the anchoring devices may be configured to generally align with an occipital bone of a wearer. For example, FIG. 11 illustrates an article 1100 having one anchoring device 1110 and FIG. 12 illustrates an article 1200 comprising a plurality of anchoring devices, specifically anchoring devices 1210 and 1212. FIG. 13 illustrates an additional embodiment of an article 1300 having a different build than the cap 100 shown in FIG. 1A-1C. In particular, rather than the article 1300 having seams that extend orthogonal to the edge 1330 of the article 1300, a plurality of panels forming the body of the article 1300 can run in different directions. Nevertheless, similar to the cap 100, the article 1300 can be equipped with a slit 1320 through which the anchoring device 1310 can extend to move from anchoring state to a hidden state in accordance with aspects herein.

The following clauses represent example aspects of concepts contemplated herein. Any one of the following clauses may be combined in a multiple dependent manner to depend from one or more other clauses. Further, any combination of dependent clauses (clauses that explicitly depend from a previous clause) may be combined while staying within the scope of aspects contemplated herein. The following clauses are examples and are not limiting.

Clause 1. A headwear article comprising: a first layer having a first surface and a second surface; a first anchoring device coupled to the first surface at a first side of the first layer; a second anchoring device coupled to the first surface at a second side of the first layer, wherein the first side and the second side of the first layer are configured to align with temporal bone portions of a wearer's head, respectively, when the headwear article is in an as-worn configuration; and a second layer coupled to the first layer at least at a first perimeter edge of the first layer, the second layer having an inner surface and an outer surface, wherein the second layer extends exterior to and overlaps with the first layer, such that the first surface of the first layer is in a face-sharing relationship with the inner surface of the second layer when the headwear article is in the as-worn configuration, wherein the second layer is configured to cover a portion of the wearer's head when the headwear article is in the as-worn configuration, the second layer further comprising: a first slit aligned with the first anchoring device coupled to the first layer, the first slit forming a first passageway for the first anchoring device through the second layer; and a second slit aligned with the second anchoring device coupled to the first layer, the second slit forming a second passageway for the second anchoring device through the second layer.

Clause 2. The headwear article of clause 1, wherein the first anchoring device and the second anchoring device are configured to move from a hidden state to an anchoring state when the first anchoring device is extended through the first slit of the second layer, and when the second anchoring device is extended through the second slit of the second layer.

Clause 3. The headwear article of clause 2, wherein the first anchoring device and the second anchoring device, when in the anchoring state, are configured to engage elastic ear loops of a face mask respectively.

Clause 4. The headwear article of any one of clauses 1 to 3, wherein the first anchoring device and the second anchoring device are secured to the first surface of the first layer by threading a thread through one or more openings of the first anchoring device and the second anchoring device, respectively.

Clause 5. The headwear article of any one of clauses 1 to 4, wherein the first anchoring device and the second anchoring device are configured to move along at least a portion of a length of the first layer.

Clause 6. The headwear article of any one of clauses 1 to 5, further comprising a third anchoring device coupled to the first surface of the first layer at a first distance from the first anchoring device, and a fourth anchoring device coupled to the first surface of the first layer at the first distance from the second anchoring device.

Clause 7. The headwear article of any one of clauses 1 to 6, wherein the first layer forms a sweatband portion of the headwear article.

Clause 8. The headwear article of any one of clauses 1 to 7, further comprising an adjustable closure mechanism for adjusting a fit of the headwear article on the wearer's head when the headwear article is in the as-worn configuration.

Clause 9. The headwear article of any one of clauses 1 to 8, wherein the headwear article is one of a cap, a hat, or a headband.

Clause 10. The headwear article of any one of clauses 1 to 9, further comprising a visor.

Clause 11. The headwear article of clause 10, wherein the second layer is comprised of a plurality of panels joined by a plurality of seams, wherein the first slit is in alignment with a first seam of the plurality of seams extending orthogonal to the first perimeter edge coupling the first layer and the second layer, wherein the second slit is in alignment with a second seam of the one or more seams also extending orthogonal to the first perimeter edge coupling the first layer and the second layer, and wherein the first seam and the second seam are configured to align with the temporal bone portions of the wearer's head when the headwear article is in the as-worn configuration.

Clause 12. The headwear article of clause 11, wherein the first slit and the second slit are in parallel alignment with the first perimeter edge coupling the first layer and the second layer.

Clause 13. A headwear article comprising: a first layer having a first surface and a second surface; a first anchoring device coupled to the first surface of the first layer; and a second layer coupled to the first layer at least at a first perimeter edge of the first layer, the second layer having an inner surface and an outer surface, wherein the second layer extends exterior to and overlaps with the first layer, such that the first surface of the first layer is in a face-sharing relationship with the inner surface of the second layer when the headwear article is in an as-worn configuration, the second layer further comprising: a first slit aligned with the first anchoring device coupled to the first layer, the first slit forming a first passageway for the first anchoring device through the second layer.

Clause 14. The headwear article of clause 13, wherein the first anchoring device is configured to align with an occipital bone and/or parietal bone of a wearer's head, when the headwear article is in the as-worn configuration.

Clause 15. The headwear article of clause 13, further comprising a second anchoring device coupled to the first surface of the first layer.

Clause 16. The headwear article of clause 15, further comprising a second slit aligned with the second anchoring device coupled to the first surface, the second slit forming a second passageway for the second anchoring device through the second layer, wherein the first slit is in alignment with a first seam and the second slit is in alignment with a second seam of one or more seams extending orthogonal to the first perimeter edge coupling the first layer and the second layer, and wherein the first seam and the second seam are configured to align with temporal bone portions of a wearer's head when the headwear article is in an as-worn configuration.

Clause 17. The headwear article of any one of clauses 13 to 16, wherein the first anchoring device is configured to move from a hidden state to an anchoring state when the first anchoring device is extended through the first slit of the second layer.

Clause 18. The headwear article of any one of clauses 13 to 17, wherein the first anchoring device, when in the anchoring state, is configured to engage one or more elastic ear loops of a face mask.

Clause 19. The headwear article of any one of clauses 13 to 18, wherein the first anchoring device is secured to the first surface of the first layer by threading a thread through one or more openings of the first anchoring device.

Clause 20. The headwear article of any one of clauses 13 to 19, wherein the first anchoring device is configured to move along at least a portion of a length of the first layer.

Clause 21. The headwear article of any one of clauses 13 to 20, wherein the first slit is in parallel alignment with the first perimeter edge coupling the first layer and the second layer.

Clause 22. The headwear article of any one of clauses 13 to 21, wherein the first layer forms a sweatband portion of the headwear article.

Clause 23. The headwear article of any one of clauses 13 to 22, further comprising an adjustable closure mechanism for adjusting a fit of the headwear article on the wearer's head when the headwear article is in the as-worn configuration.

Clause 24. The headwear article of any one of clauses 13 to 23, wherein the headwear article is one of a cap, a hat, or a headband.

Clause 25. The headwear article of any one of clauses 13 to 24, further comprising a visor.

Clause 26. The headwear article of clause 24, wherein the second layer is comprised of a plurality of panels joined by a plurality of seams, wherein the first slit is in alignment with a first seam of the plurality of seams extending orthogonal to the first perimeter edge coupling the first layer and the second layer.

Clause 27. A headwear article comprising: a first layer having a first surface and a second surface; a first anchoring device coupled to the first surface of the first layer, the first anchoring device being configured to move from a hidden configuration to an anchoring configuration; and a second layer coupled to the first layer at least at a first perimeter edge of the first layer, the second layer having an inner surface and an outer surface, wherein the second layer extends exterior to and overlaps with the first layer such that the first surface of the first layer is in a face-sharing relationship with the inner surface of the second layer when the headwear article is in an as-worn configuration, the second layer further comprising: a first slit aligned with the first anchoring device coupled to the first layer, the first slit forming a first passageway for the first anchoring device through the second layer, wherein when the first anchoring device is in the hidden configuration, the first anchoring device is located between the first layer and the second layer, and wherein when the first anchoring device is in the anchoring configuration, the first anchoring device is positioned external to the outer surface of the second layer through the first slit.

Clause 28. The headwear article of clause 27, wherein the first anchoring device is configured to align with an occipital bone and/or parietal bone of a wearer's head, when the headwear article is in the as-worn configuration.

Clause 29. The headwear article of clause 28, further comprising a second anchoring device coupled to the first surface of the first layer.

Clause 30. The headwear article of clause 29, further comprising a second slit, wherein the first slit is in alignment with a first seam and the second slit is in alignment with a second seam of one or more seams extending orthogonal to the first perimeter edge coupling the first layer and the second layer, and wherein the first seam and the second seam are configured to align with temporal bone portions of a wearer's head when the headwear article is in the as-worn configuration.

Clause 31. The headwear article of any one of clauses 29 to 30, wherein the second anchoring device is configured to move from the hidden state to the anchoring state when the second anchoring device is extended through the second slit of the second layer.

Clause 32. The headwear article of any one of clauses 28 to 31, wherein the first anchoring device, when in the anchoring state, is configured to engage one or more elastic ear loops of a face mask.

Clause 33. The headwear article of any one of clauses 28 to 32, wherein the first anchoring device is joined to the first surface of the first layer by threading a thread through one or more openings of the anchoring device.

Clause 34. The headwear article of any one of clauses 28 to 33, wherein the first anchoring device is configured to move along at least a portion of a length of the first layer.

Clause 35. The headwear article of any one of clauses 28 to 34, wherein the first slit is in parallel alignment with the first perimeter edge coupling the first layer and the second layer.

Clause 36. The headwear article of any one of clauses 28 to 35, wherein the first layer forms a sweatband portion of the headwear article.

Clause 37. The headwear article of any one of clauses 28 to 36, further comprising an adjustable closure mechanism for adjusting a fit of the headwear article on the wearer's head when the headwear article is in the as-worn configuration.

Clause 38. The headwear article of any one of clauses 28 to 37, wherein the headwear article is one of a cap, a hat, or a headband.

Clause 39. The headwear article of any one of clauses 28 to 38, further comprising a visor.

Clause 40. The headwear article of clause 39, wherein the second layer is comprised of a plurality of panels joined by a plurality of seams, wherein the first slit is in alignment with a first seam of the plurality of seams extending orthogonal to the first perimeter edge coupling the first layer and the second layer.

Clause 41. A headwear article comprising: an anchoring device joined to a first surface of a first layer of the headwear article, wherein the anchoring device is adapted to reversibly move from a hidden state to an anchoring state and wherein the anchoring device is configured to engage at least one elastic ear loop of a face mask when said anchoring device is in said anchoring state.

Clause 42. The headwear article of clause 41, wherein the anchoring device comprises a base portion, an anchoring portion, and a body portion joining the base portion to the anchoring portion, wherein the base portion is joined to the first surface of the first layer, and wherein the body portion is comprised of an elastomeric material.

Clause 43. The headwear article of clause 42, wherein in the hidden state, the base portion and the anchoring portion are separated by a first distance, and wherein in the anchoring state, the base portion and the anchoring portion are separated by a second distance that is greater than the first distance.

Clause 44. The headwear article of clause 43, further comprising a second layer coupled to the first layer at least at a first perimeter edge of the first layer, the second layer having an inner surface and an outer surface, wherein the second layer extends exterior to and overlaps with the first layer, such that the first surface of the first layer is in a face-sharing relationship with the inner surface of the second layer when the headwear article is in an as-worn configuration.

Clause 45. The headwear article of clause 44, wherein the second layer comprises a slit aligned with the anchoring device coupled to the first surface of the first layer, the slit forming a passageway for an anchoring portion of the anchoring device to pass through the second layer when the anchoring device is in the anchoring state.

Clause 46. The headwear article of any one of clauses 41 to 45, wherein the anchoring device is joined to the first surface of the first layer by threading a thread through one or more openings of the anchoring device.

Clause 47. The headwear article of any one of clauses 41 to 46, wherein a position of the anchoring device is configured to align with an occipital bone area of a wearer when the headwear article is an as-worn configuration.

Clause 48. The headwear article of any one of clauses 41 to 47, wherein a position of the anchoring device is configured to align with a temporal bone portion of a wearer when the headwear article is in an as-worn configuration.

Clause 49. The headwear article of any one of clauses 41-48, wherein the anchoring device comprises at least one of a button or a hook.

Aspects of the present disclosure have been described with the intent to be illustrative rather than restrictive. Alternative aspects will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

What is claimed is:

1. A headwear article comprising:
a first layer having a first surface and a second surface;
a first anchoring device coupled to the first surface of the first layer; and
a second layer coupled to the first layer at least at a first perimeter edge of the first layer, the second layer having an inner surface and an outer surface, wherein the second layer extends exterior to and overlaps with the first layer, such that the first surface of the first layer is in a face-sharing relationship with the inner surface of the second layer when the headwear article is in an as-worn configuration, the second layer further comprising:
a first slit aligned with the first anchoring device coupled to the first layer, the first slit forming a first passageway for the first anchoring device through the second layer.

2. The headwear article of claim 1, wherein the first anchoring device is configured to align with an occipital bone and/or parietal bone of a wearer's head, when the headwear article is in the as-worn configuration.

3. The headwear article of claim 1, further comprising a second anchoring device coupled to the first surface of the first layer.

4. The headwear article of claim 3, further comprising a second slit aligned with the second anchoring device coupled to the first surface, the second slit forming a second passageway for the second anchoring device through the second layer, wherein the first slit is in alignment with a first seam and the second slit is in alignment with a second seam of one or more seams extending orthogonal to the first perimeter edge coupling the first layer and the second layer, and wherein the first seam and the second seam are configured to align with temporal bone portions of a wearer's head when the headwear article is in an as-worn configuration.

5. The headwear article of claim 1, wherein the first anchoring device is configured to move from a hidden state to an anchoring state when the first anchoring device is extended through the first slit of the second layer.

6. The headwear article of claim 1, wherein the first anchoring device, when in the anchoring state, is configured to engage one or more elastic ear loops of a face mask.

7. The headwear article of claim 1, wherein the first anchoring device is secured to the first surface of the first layer by threading a thread through one or more openings of the first anchoring device.

8. The headwear article of claim 1, wherein the first anchoring device is configured to move along at least a portion of a length of the first layer.

9. The headwear article of claim 1, wherein the first slit is in parallel alignment with the first perimeter edge coupling the first layer and the second layer.

10. The headwear article of claim 1, wherein the first layer forms a sweatband portion of the headwear article.

11. The headwear article of claim 1, further comprising an adjustable closure mechanism for adjusting a fit of the headwear article on the wearer's head when the headwear article is in the as-worn configuration.

12. The headwear article of claim 1, wherein the headwear article is one of a cap, a hat, or a headband.

13. The headwear article of claim 1, further comprising a visor.

14. The headwear article of claim 13, wherein the second layer is comprised of a plurality of panels joined by a plurality of seams, wherein the first slit is in alignment with a first seam of the plurality of seams extending orthogonal to the first perimeter edge coupling the first layer and the second layer.

15. A headwear article comprising:
a first layer having a first surface and a second surface;
a first anchoring device coupled to the first surface of the first layer, the first anchoring device being configured to move from a hidden configuration to an anchoring configuration; and
a second layer coupled to the first layer at least at a first perimeter edge of the first layer, the second layer having an inner surface and an outer surface, wherein the second layer extends exterior to and overlaps with the first layer such that the first surface of the first layer is in a face-sharing relationship with the inner surface of the second layer when the headwear article is in an as-worn configuration, the second layer further comprising:
a first slit aligned with the first anchoring device coupled to the first layer, the first slit forming a first passageway for the first anchoring device through the second layer,
wherein when the first anchoring device is in the hidden configuration, the first anchoring device is located between the first layer and the second layer, and
wherein when the first anchoring device is in the anchoring configuration, the first anchoring device is positioned external to the outer surface of the second layer through the first slit.

16. The headwear article of claim 15, wherein the first anchoring device is configured to align with an occipital bone and/or parietal bone of a wearer's head, when the headwear article is in the as-worn configuration.

17. The headwear article of claim 15, further comprising a second anchoring device coupled to the first surface of the first layer.

18. The headwear article of claim 17, further comprising a second slit, wherein the first slit is in alignment with a first seam and the second slit is in alignment with a second seam of one or more seams extending orthogonal to the first perimeter edge coupling the first layer and the second layer, and wherein the first seam and the second seam are configured to align with temporal bone portions of a wearer's head when the headwear article is in the as-worn configuration.

19. The headwear article of claim 18, wherein the second anchoring device is configured to move from the hidden state to the anchoring state when the second anchoring device is extended through the second slit of the second layer.

20. A headwear article comprising:
an anchoring device joined to a first surface of a first layer of the headwear article, wherein the anchoring device is adapted to reversibly move from a hidden state to an anchoring state and wherein the anchoring device is configured to engage at least one elastic ear loop of a face mask when said anchoring device is in said anchoring state.
